(19) United States
(12) Patent Application Publication
(10) Pub. No.: US 2021/0255112 A1
(43) Pub. Date: Aug. 19, 2021

(54) ROBOTIC INSPECTION SYSTEM FOR STRUCTURAL COLUMNS

(71) Applicant: INFRASTRUCTURE PRESERVATION CORPORATION, Clearwater, FL (US)

(72) Inventor: William SEAVEY, Clearwater, FL (US)

(21) Appl. No.: 17/178,884

(22) Filed: Feb. 18, 2021

Related U.S. Application Data
(60) Provisional application No. 62/977,847, filed on Feb. 18, 2020.

(51) Int. Cl. G01N 21/88; G01N 21/954

(52) U.S. Cl. CPC G01N 21/8803; G01N 2201/102; G01N 21/954

(57) ABSTRACT

A robotic inspection system for structural columns includes a command center, and a winch structure having support legs, a pulley, a winch, and cable passing over the pulley, where the winch structure is configured to record a length of the cable payed out over the pulley. A robotic device is coupled to the cable. The robotic device includes a main body configured to be lowered down inside a structural column, and a plurality of arms are connected to, and extending away from the main body. In addition, the robotic device includes a plurality of rotors where a rotor is coupled to a distal end of each of the arms and each rotor is configured to be remotely controlled to rotate in a desired direction. A high definition camera and a plurality of orientation cameras are mounted to the main body, where the high definition camera is configured to be controlled independently. A digital transmitter is configured to transmit a multiplexed output to the command center.

### RELATED APPLICATIONS

The present invention claims priority to Provisional Patent Application Ser. No. 62/977,847 filed Feb. 18, 2020, the entire contents of thereof incorporated herein by reference.

### TECHNICAL FIELD

The present invention relates to the field of structural inspections, and, more particularly, to a robotic inspection system for structural columns and related methods.

### BACKGROUND

Structural columns of large segmental bridges are currently being inspected by lowering inspectors on a hoist into a confined space inside the structural columns. The inspector typically must wear an oxygen mask and use a flashlight and a hand held camera while being suspended within the structural column to perform the inspection. The poor lighting conditions of the inside of the structural column make it difficult for the inspector to perform a thorough inspection.

Accordingly, what is needed is an inspection system that can perform inspections of structural columns of bridges safely and with increased coverage from the bottom to the top.

### SUMMARY

In a particular embodiment, a robotic inspection system for structural columns is disclosed. The inspection system includes a command center, and a winch structure having support legs, a pulley, a winch, and cable passing over the pulley. The winch is secured to the support legs. The winch structure is configured to record a length of the cable payed out over the pulley and a robotic device is coupled to the cable. The robotic device includes a main body configured to be lowered down inside a structural column, and a plurality of arms are connected to, and extending away from the main body. In addition, the robotic device includes a plurality of rotors where a rotor is coupled to a distal end of each of the arms and each rotor can be remotely controlled to rotate in a desired direction. A high definition camera is mounted to the main body, where the high definition camera is configured to be controlled independently. The robotic device also includes a plurality of orientation cameras mounted to the main body and configured to provide a complete view within the structural column. A digital transmitter is coupled to the high definition camera and the plurality of orientation cameras, where the transmitter is configured to transmit a multiplexed output from inside the structural column to the command center.

### BRIEF DESCRIPTION OF THE DRAWINGS

FIG. 1 is a front perspective view of a robotic device of a robotic inspection system for structural columns in accordance with the present disclosure;

FIG. 2 is a side perspective view of the robotic device of FIG. 1;

FIG. 3 is a detail view of the robotic device of FIG. 1;

FIG. 4 is a perspective of the robotic inspection system prepared to be deployed within a structural column;

FIG. 5 is a perspective view of a winch structure used to deploy the robotic device of FIG. 1;

FIG. 6 is a perspective view of the robotic device of the inspection system being positioned for deployment;

FIG. 7 is a perspective view of the robotic device showing a plurality of rotors at a first orientation; and

FIG. 8 is a perspective view of the robotic device having the plurality of rotors being rotated to a desired direction in order to control a position of the robotic device.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The robotic inspection system implements high definition video during the inspection of the structural columns. This allows an inspector to visually see any imperfections in the columns without having to physically enter the structural column itself. In addition, the video is stored to create a history of each of the inspections. Accordingly, a comparison with each subsequent inspection cycle can be performed to determine rates of deterioration over time as well as reporting areas that may need immediate attention.

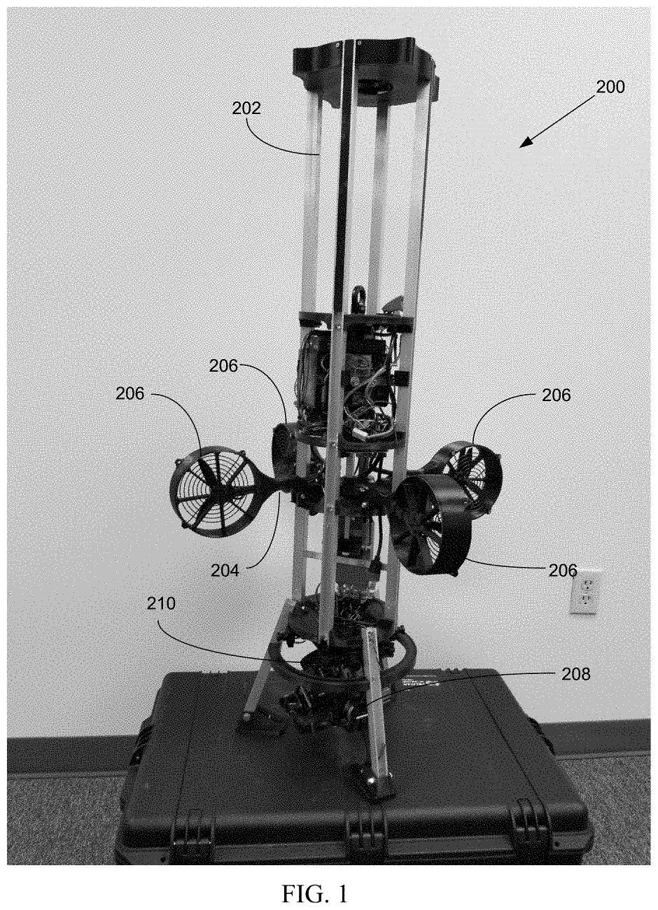

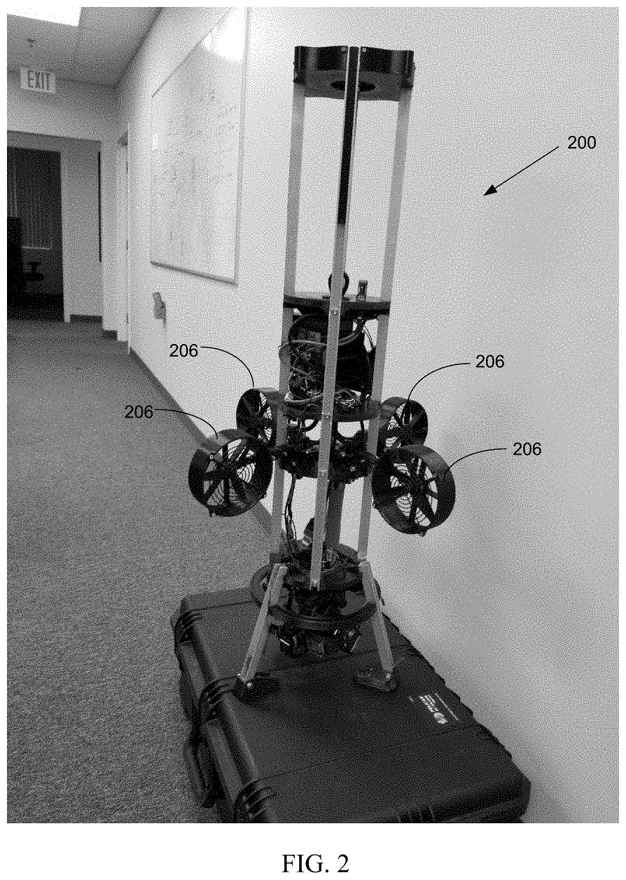

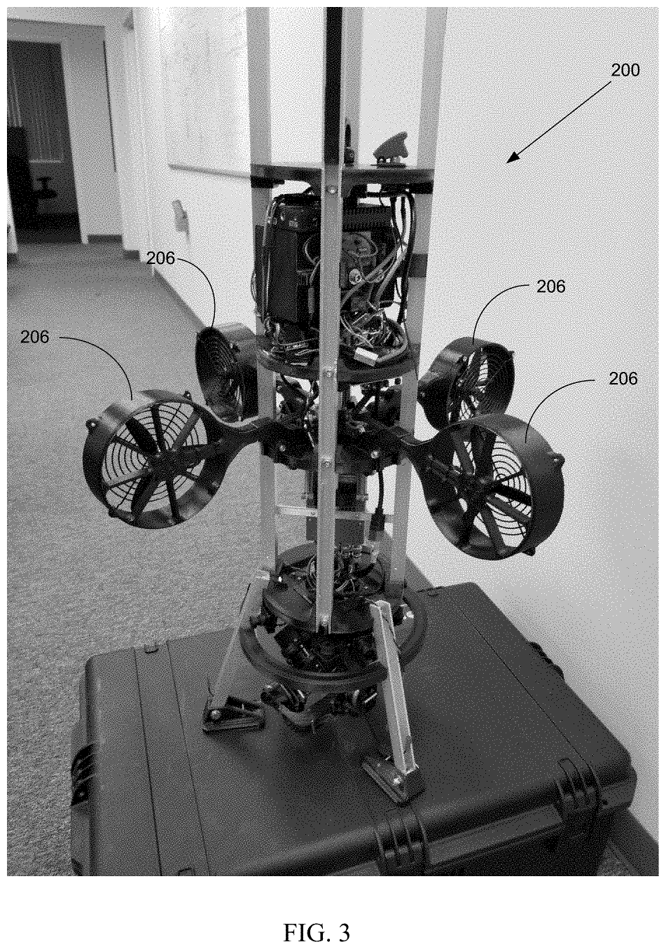

Referring now to FIGS. 1-3, a robotic device 200 is shown. The robotic device 200 includes a main body 202 ready to be lowered inside the structural column using an access opening. A plurality of arms 204 are connected to, and extending away from the main body 202. A plurality of rotors 206 are mounted to the main body 202, wherein a rotor 206 is coupled to a distal end of each of arms 204 and each rotor 206 can be remotely controlled to rotate in a desired direction.

A high definition camera 208 is mounted to the main body 202, where the high definition camera 208 is configured to be controlled independently. In addition, a plurality of orientation cameras 210 are also mounted to the main body 202 and are configured to provide a complete view within the structural column.

A digital transmitter 212 is coupled to the high definition camera 208 and the plurality of orientation cameras 210, where the digital transmitter 212 is configured to transmit a multiplexed output from inside the structural column to the command center.

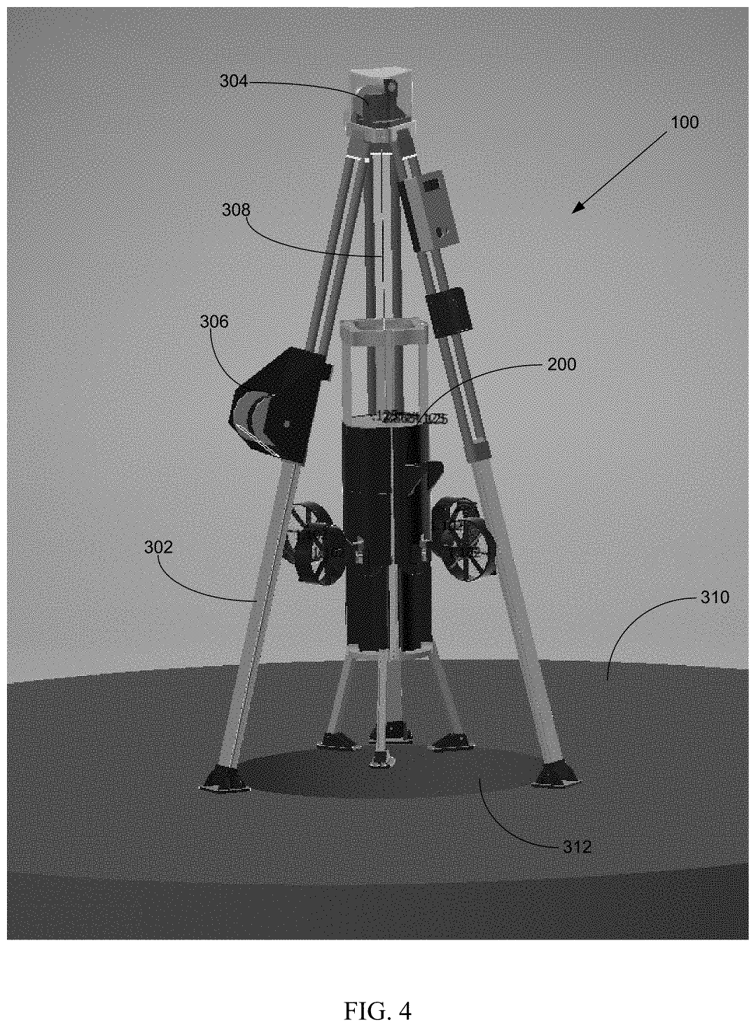

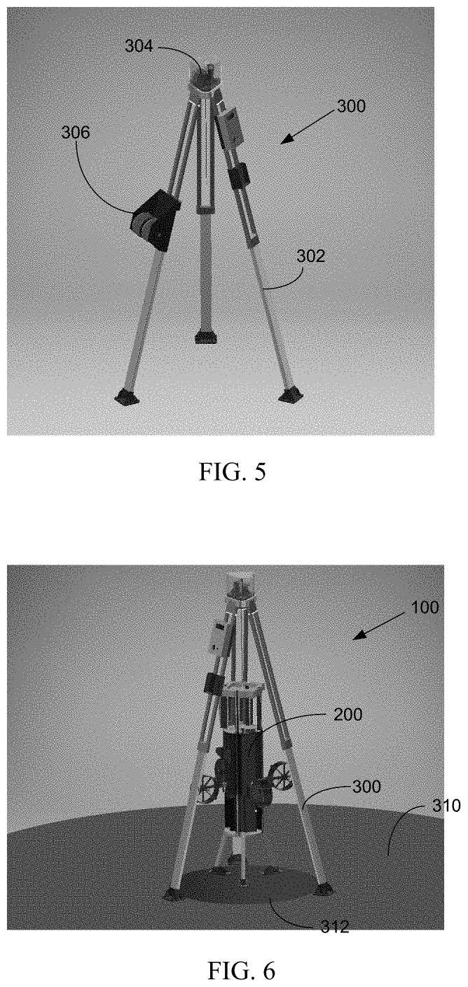

Referring now to FIGS. 4-6, the robotic inspection system 100 is illustrated. A winch structure 300 includes support legs 302, a pulley 304, a winch 306, and a cable 308 passing over the pulley 304. The winch 306 is secured to the support legs 302. The winch structure 300 is configured to record a length of the cable 308 payed out over the pulley 304 and the robotic device 200 is coupled to the free end of the cable 308.

A command center (not shown) may be synchronized to the robotic device 200. The robotic device 200 is lowered into a structural column 310 using the cable 308 secured to a winch 306. The winch 306 is positioned over the access opening 312 and is configured to position the robotic device 200 at a desired height within the structural column 310 to perform the inspection. The cable 308 on the winch 306 may have markers that indicate the length that has been unwound from the winch 306 in order to determine the relative vertical location of the robotic device 200 within the structural column 310 from the elevation of the access opening 312. As those of ordinary skill in the art can appreciate, other devices and methods may be implemented to record the length of the cable 308 that has been payed out in order to determine a vertical position of the robotic device 200.

The robotic device 200 is configured to visually inspect the structural column 310 and the inspection can be recorded. In addition, real time monitoring of the inspection of the structural column 310 can be done as the robotic device 200 is positioned within the structural column 310. The robotic device 200 may include a high definition multiplexed video monitoring system 208 (e.g., 1080i and 60 fps).

The robotic device 200 may include wireless communications equipment in order to receive command and control signals and also to wirelessly transmit video. This eliminates transmission cables that would otherwise be needed. Transmission cables could also be coupled to the robotic device 200 in addition to, or as an alternative to, the wireless communication equipment.

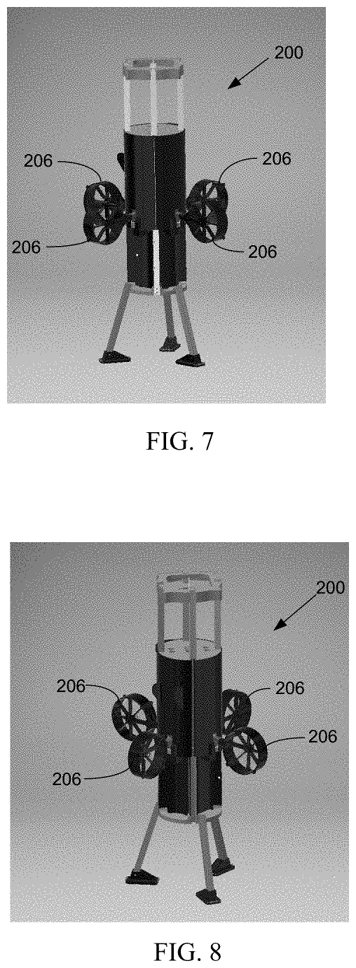

Referring now to FIGS. 7 and 8, the robotic device 200 has four arms 204 connected to, and extending away, from a main body 202 with a respective rotor 206. The rotors 206 are configured to rotate direction and can also vary a speed at which the impeller of the rotor spins. Thus, as shown in FIG. 7 the rotors have a direction parallel to the robotic device 200. However, the rotors 206 have been adjusted in FIG. 8 so that have been tilted downward. Accordingly, as the robotic device 200 is lowered on the cable 308, the rotors 206 can be activated and rotated to control the movement of the robotic device 200. This prevent the uncontrollable spinning of the robotic device 200 as it descends and also allows for improved photography during the inspection process.

The output of the high definition and orientation cameras 208, 210 may provide high quality moving images (video) and a high quality video recording (e.g., 1080i and 60 fps). The camera lens zoom and focus features are typically fixed but may be variable. In addition, each of the cameras 208, 210 may be mounted on an angle adjustment mechanism that allows the respective camera to pivot up and down. The control of the angle of the respective camera may be accomplished by the remote controls.

The robotic device 200 is configured to fit within the access opening 312 of the structural column 310 and travel the depth of the structural column 310 while being fully controlled and monitored remotely. The robotic device 200 may include a power supply in electrical communication with the rotors 306 and the cameras 208, 210.

The command center positioned outside the structural column 310 may include a base housing several video monitors that are used for displaying images from cameras 208, 210. The wireless video capability allows the robotic device 200 to transmit a wireless multiplexed output of the cameras 208, 210 through a wireless RF digital video transmitter. The multiplexing of the cameras 208, 210 allows all the cameras to be transmitted in one signal. The multiplexer may be part of one or more the cameras 208, 210.

In operation, the robotic device 200 is positioned over the access opening 312 of the structural column 310. The robotic device 200 is then powered up. The robotic device 200 is configured to perform a short diagnostic to insure that the communications are working and that the mechanical robotics are functional and remote controllable.

The next step is to make sure all the rotors 206 and the cameras 208, 210 are moving and controllable. The next step is to confirm that the video is of high quality from all the cameras 208, 210. The cameras 208, 210 should also be consistent from one to the other. If a camera 208, 210 is out of compliance, that camera is replaced with a replacement of the same model. Once all the cameras 208, 210 are operational, a record unit of the command center is activated. Once all functionalities are confirmed, then the recording is checked for performance and quality. In addition, the power system is checked for appropriate amps and voltage.

The robotic device 200 is then deployed down the inside of the structural column 310. The cameras 208, 210 may be tilted up or down to view and record the condition inside of the structural column 310. Movement of the robotic device 200 is paused while the recorded video is reviewed for any points of interest or to determine if the video is missing an area. The robotic device is then monitored and any additional areas recorded as the robotic device travels upwards back to the access opening 312.

If a point of concern or a fault is found on the structural column 310, the location is recorded. Once the robotic device 200 has finished the inspection and is lifted out of the access opening 312, the robotic device 200 and winch structure 300 can be moved and prepared for the next structural column 310.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A robotic inspection system for structural columns comprising:
a command center;
a winch structure having support legs, a pulley, a winch and cable passing over the pulley, the winch secured to the support legs, wherein the winch structure is configured to record a length of a cable payed out over the pulley; and
a robotic device coupled to the cable, the robotic device comprising
a main body configured to be lowered down inside a structural column,
a plurality of arms connected to, and extending away from the main body,
a plurality of rotors, wherein a rotor is coupled to a distal end of each of arms and each rotor can be remotely controlled to rotate in a desired direction,
a high definition camera mounted to the main body, wherein the high definition camera is configured to be controlled independently,
a plurality of orientation cameras mounted to the main body and configured to provide a complete view within the structural column, and
a digital transmitter coupled to the high definition camera and the plurality of orientation cameras, wherein the transmitter is configured to transmit a multiplexed output from inside the structural column to the command center.
